(19) United States
(12) Patent Application Publication
(10) Pub. No.: US 2009/0202212 A1
(43) Pub. Date: Aug. 13, 2009

(54) Cable slack storage rack

(76) Inventors: Terry D. Cox, Keller, TX (US); Marcel G. Mures, Fort Worth, TX (US); Diana Rodriguez, Fort Worth, TX (US)

Correspondence Address: CORNING INCORPORATED, INTELLECTUAL PROPERTY DEPARTMENT, SP-TI-3-1, CORNING, NY, 14831, US

(21) Appl. No.: 12/069,639

(22) Filed: Feb. 12, 2008

(51) Int. Cl. G02B 6/00

(52) U.S. Cl. 385/135

(57) ABSTRACT

A cable slack storage rack includes a first and second cable zone and a medial portion disposed between them. The first and second cable zones have one or more cable keepers, each of which may define an opening therein for receiving cable for slack storage. The cable slack storage rack may have one or more stacking features, thereby making the racks modular for adding additional slack storage as necessary. In other words, the cable slack storage rack may include one or more stacking features for stackably connecting a second cable slack storage rack to a first cable slack storage rack. By way of example, the first cable zone may carry a pivot profile and the second cable zone may carry a retention tab. In another embodiment, the medial portion may define a coupling slot adapted to receive a coupler as the stacking feature.

### FIELD OF THE INVENTION

The present disclosure is directed generally to cable slack storage racks for network communication devices. More particularly, the disclosure is directed to cable slack storage racks for mounting to a fiber optic terminal, to a fiber optic convergence point housing, or to a similar device for storing bundles of cable such as fiber optic cable.

### BACKGROUND OF THE INVENTION

Extra cable at the end of a cable run, such as at the end of a fiber optic cable run, often is not cut from the cable length but instead, for advantageous purposes, is bundled and saved in-line at the termination point. Should a particular connection at a termination point later be re-spliced, for example, the extra length required for the new connection is available for use from the bundle. This extra length is referred to as cable slack.

So that the cable slack may be used in the future for the purposes for which it was saved, it is desirable that the cable slack of a single cable line be neatly stored in an organized fashion. Furthermore, often numerous cable runs end at a single such termination site, such as a local convergence point, resulting in the presence of numerous cable slack bundles—with a view toward future use of the cable slack at such a location, it is desirable that each of the bundles be neatly stored in an organized fashion and that the individual bundles themselves be separate and distinguishable. It is also desirable that the cable bundles associated with a particular termination site be stored upon or close to structures carrying the termination site, such as near a network device, upon a terminal, or upon the housing of a local convergence site, for ease of access and for space savings.

Still further, certain types of cables, such as fiber optic cables, ought not be bent beyond a minimum bend radius, to maintain optimum performance of the cable system. Thus, in bundling the cable slack for such cabling, it is desirable not to surpass the minimum bend radius for that specific cabling, for example to avoid attenuation of the signal carried by the cable.

Presently, cable slack often is stored simply by draping it over a J-bracket or similar projection. Unfortunately, such a practice is not optimal, as it lends itself toward the entanglement of a cable line with itself, toward the entanglement of one cable line with another, and toward the development of pinch points that may surpass minimum bend radius specifications. Thus, there is an unresolved need in the industry for devices that easily and conveniently organize the storage of cable slack.

### BRIEF SUMMARY OF THE INVENTION

The present invention is directed to devices for quickly and easily storing cable slack in a neat, organized arrangement. The present invention provides for the orderly arrangement of multiple cable slack bundles at a single location, for the stacking of separate bundles, and for the avoidance of surpassing minimum bend radius specifications.

One embodiment of the present invention is directed toward a cable slack storage rack that includes first and second cable zones, with a medial portion disposed between the first and second cable zones. The first cable zone carries one or more cable keepers. Each such cable keeper defines an opening therein for receiving cable. Likewise, the second cable zone carries one or more cable keepers, each such cable keeper defining an opening therein for receiving cable. The openings are configured for retaining the cable during wind, rain and the like, but the cable may also be further secured to the cable slack storage rack using tie-wraps or the like. In one embodiment, the first and second cable zones have an equal number of cable keepers, but unequal number of cable keepers are possible with the concepts of the invention.

In still another embodiment of the present invention, the cable slack storage racks are modular for adding additional cable storage as necessary. For instance, stacking features are provided for connecting a first cable slack storage rack with a second cable slack storage rack. Such stacking features can be embodied in a variety structures according to the concepts of the present invention. By way of example, stacking features may include the first cable zone carrying a pivot profile adapted to receive a hinge pin therein for pivotly connecting a second cable slack storage rack. Additionally, the second cable zone may carry a retention feature such as a retention tab for securing the second cable slack storage rack in stored position. In other embodiments, such stacking feature is incorporated in the medial portion of the cable slack storage rack. For instance, the medial portion of the cable slack storage rack can define within it a coupling slot, the coupling slot being adapted to receive within it a coupler for adding a second cable slack storage rack. Still other embodiments can include stacking features such as stacking ribs and cavities that interlock. Additionally, the cable slack storage racks of the present invention may be carried by a network device such as an aerial closure or the like.

It is to be understood that both the foregoing general description and the following detailed description present embodiments of the disclosure, and are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The foregoing and other features, aspects and advantages of the present disclosure may be better understood when the following detailed description is read with reference to the accompanying drawings, in which:

FIG. 1 is a perspective view of a cable slack storage rack according to one embodiment of the present invention;

FIG. 2A is an environmental perspective view showing the cable slack storage rack of FIG. 1 carried by a network device according to the present invention;

FIG. 2B is an environmental perspective view of a plurality of cable slack storage racks carried by a network device according to the present invention;

FIG. 3A is a front perspective view of a cable slack storage rack according to another embodiment of the present invention;

FIG. 3B is a back perspective view of another cable slack storage rack that is similar to the cable slack storage rack of FIG. 3A according to the present invention;

FIG. 3C is an exploded perspective view of a cable slack storage rack system, depicting two cable slack storage racks of FIGS. 3A and 3B along with a hinge pin according to the present invention;

FIG. 3D is a detailed perspective view of the hinge pin of FIG. 3C adapted for use in connecting two cable slack storage racks according to the present invention;

FIG. 3E is an assembled perspective view of a cable slack storage rack system, depicting two cable slack storage rack system of FIG. 3C;

FIG. 4A is an exploded perspective view of a cable slack storage rack system, depicting two cable slack storage racks and a coupler according to a further embodiment of the present invention; and

FIG. 4B is an assembled perspective view of a cable slack storage rack system of FIG. 4A.

### DETAILED DESCRIPTION OF THE DISCLOSURE

The present disclosure will now be described more fully hereinafter with reference to the accompanying drawings in which exemplary embodiments of the disclosure are shown. However, aspects of this disclosure may be embodied in many different forms and should not be construed as limited to the embodiments set forth herein. These exemplary embodiments are provided so that this disclosure will be both thorough and complete, and will fully convey the scope of the disclosure to those skilled in the art. Whenever possible, like reference numerals will be used throughout the detailed description of the disclosure to refer to like or similar elements of the various drawings.

The present disclosure generally provides various embodiments of a cable slack storage rack for quickly and easily storing cable slack. The disclosed cable slack storage rack is advantageous as providing for the orderly arrangement of a cable slack bundle, providing for the orderly storage and arrangement of multiple cable slack bundles at a single location, providing for the stacking of separate cable slack bundles, avoiding the surpassing of minimum bend radius specifications for cabling, and providing other benefits as will be apparent to those of skill in this art. Cable slack storage racks are also advantageous because the craft can quickly and easily mount them to network devices such as an aerial closure, telephone pole, or the like. Moreover, the cable slack storage racks may have a modular configuration allowing the use of multiple racks.

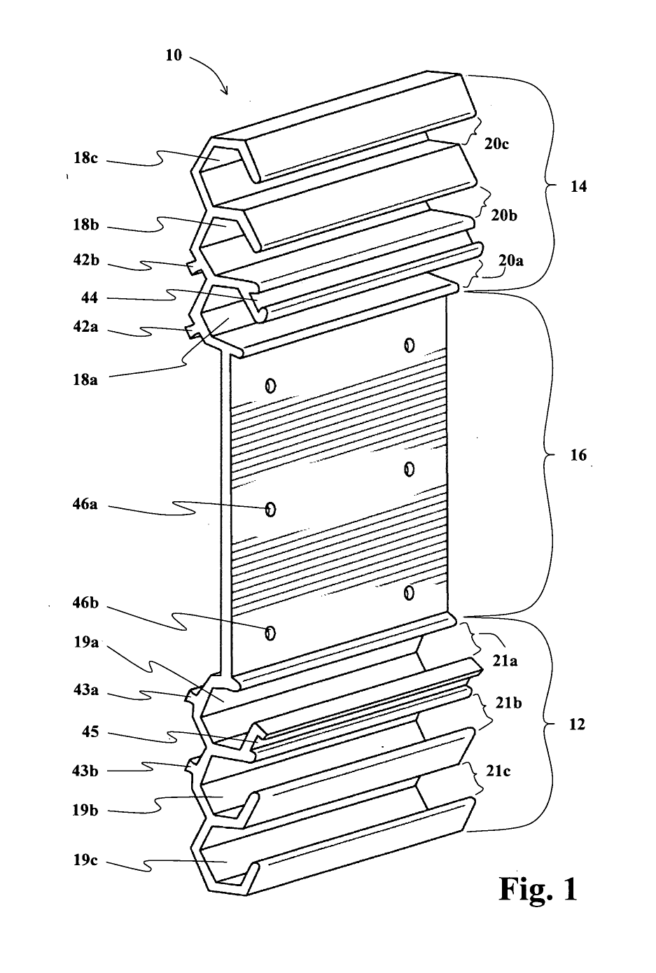

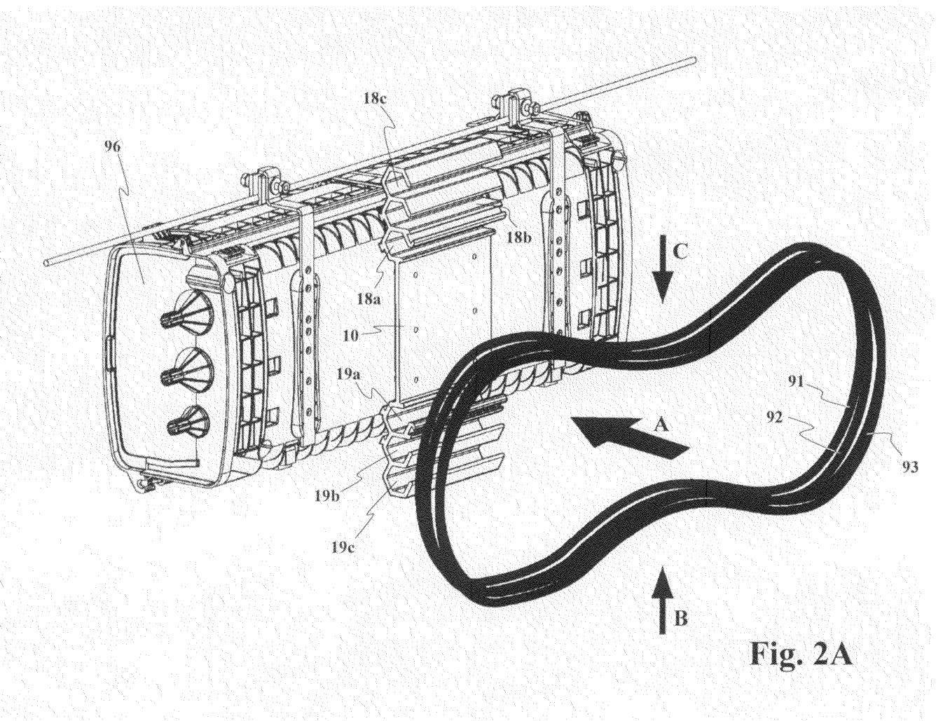

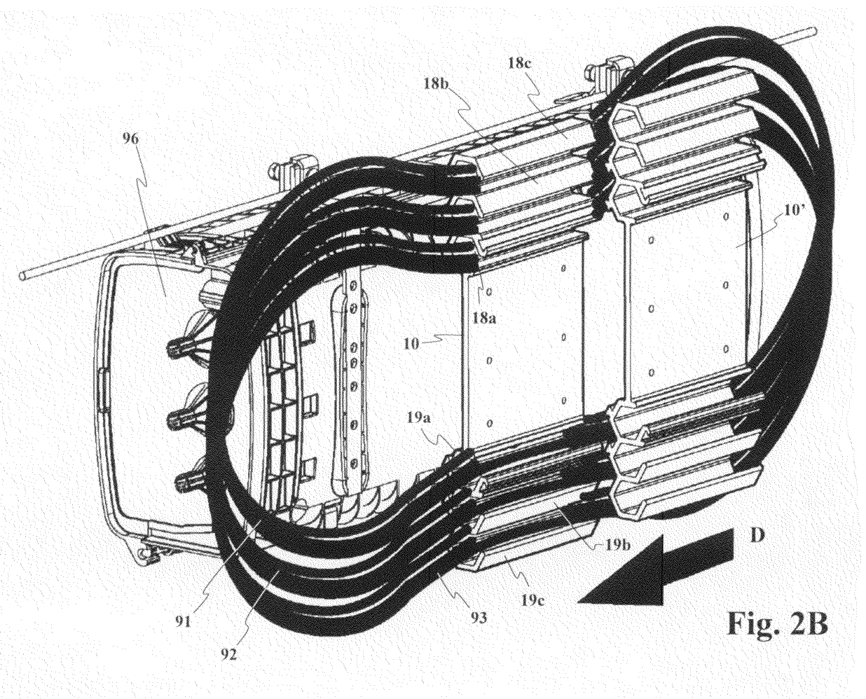

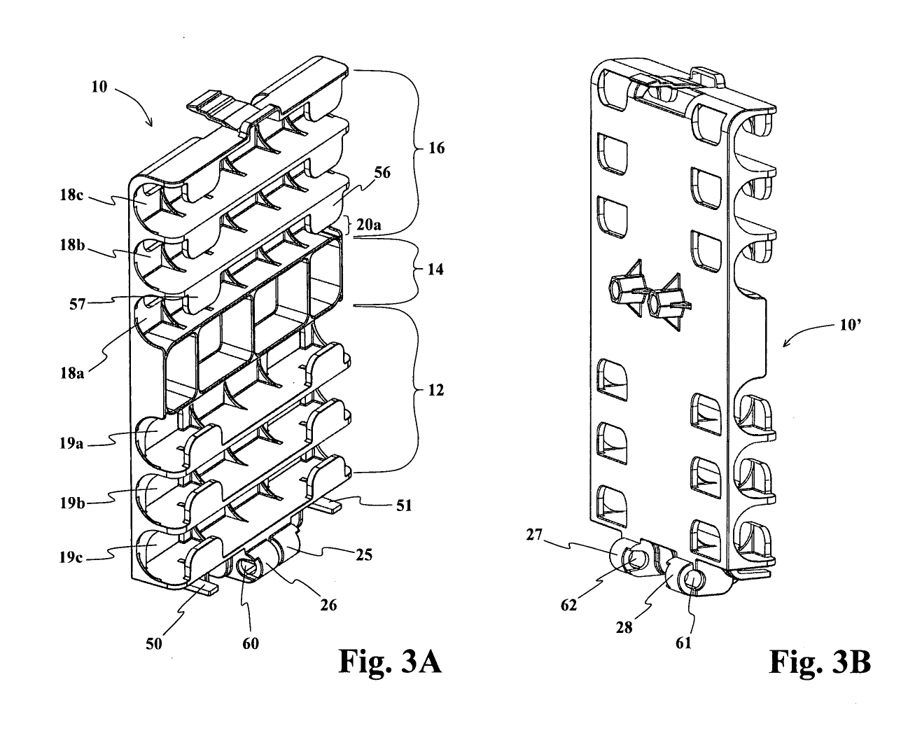

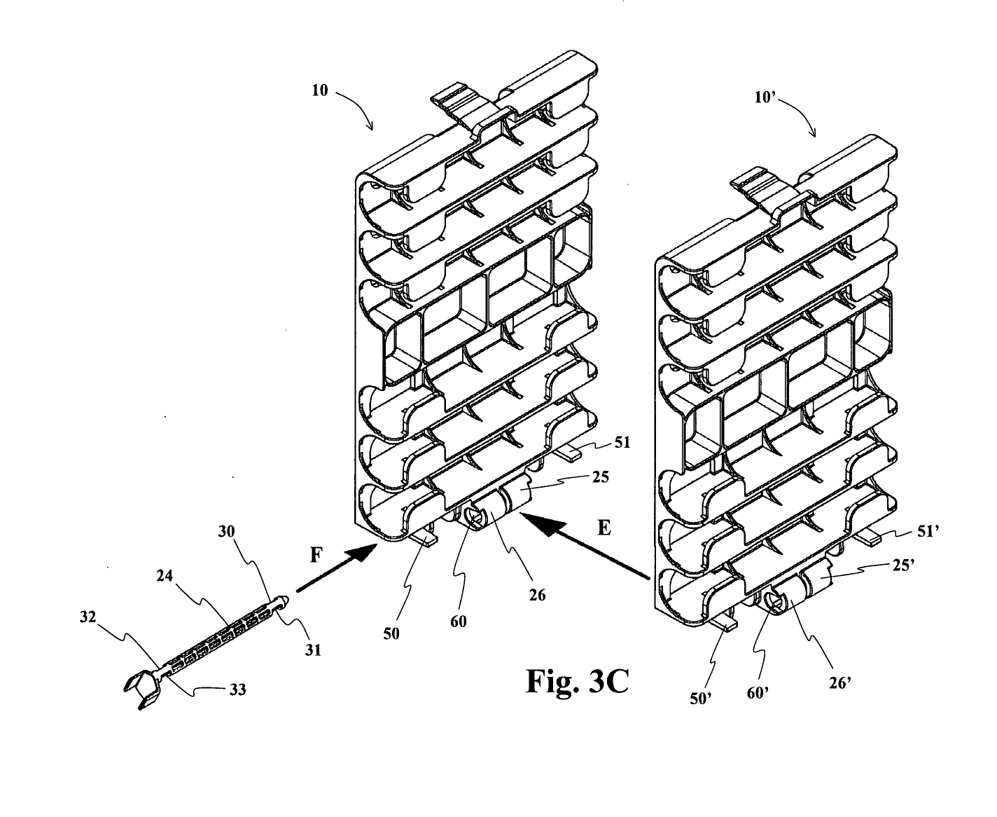

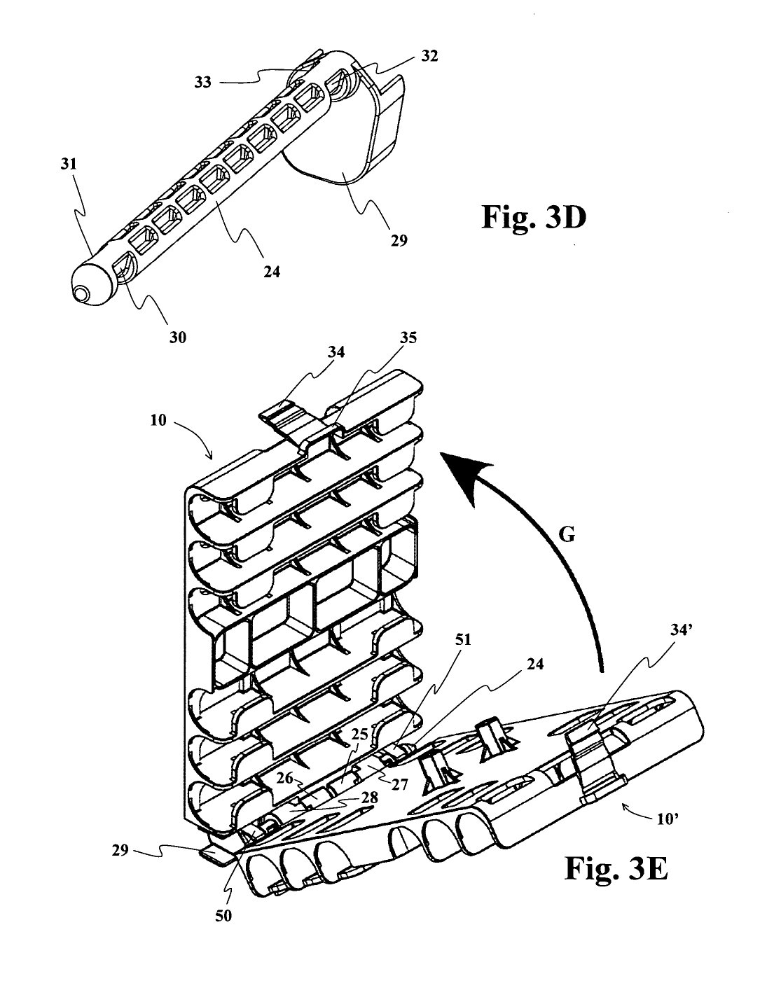

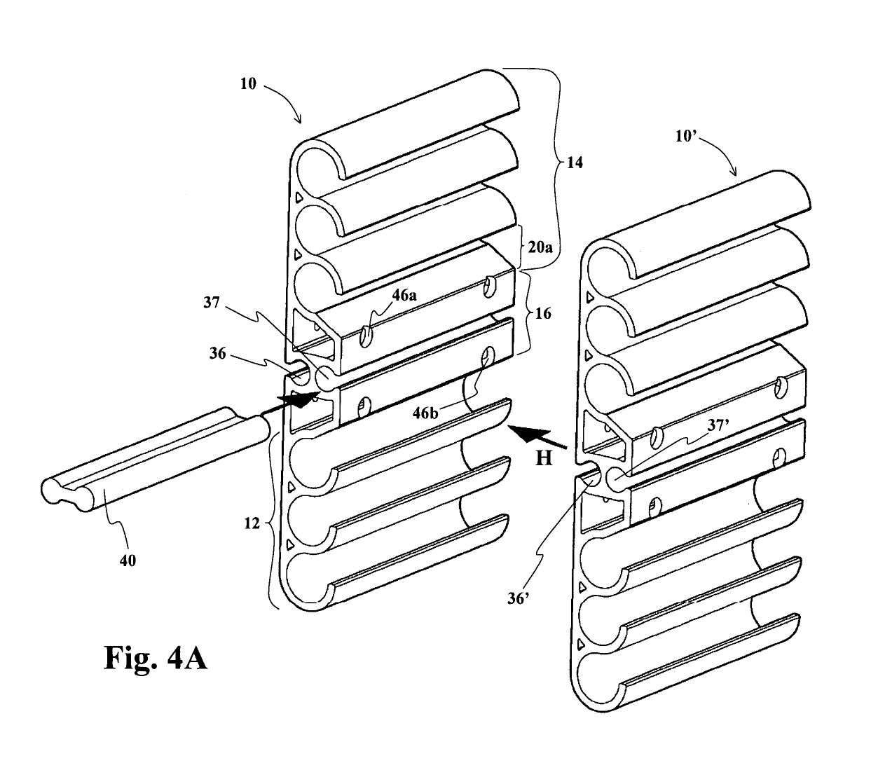

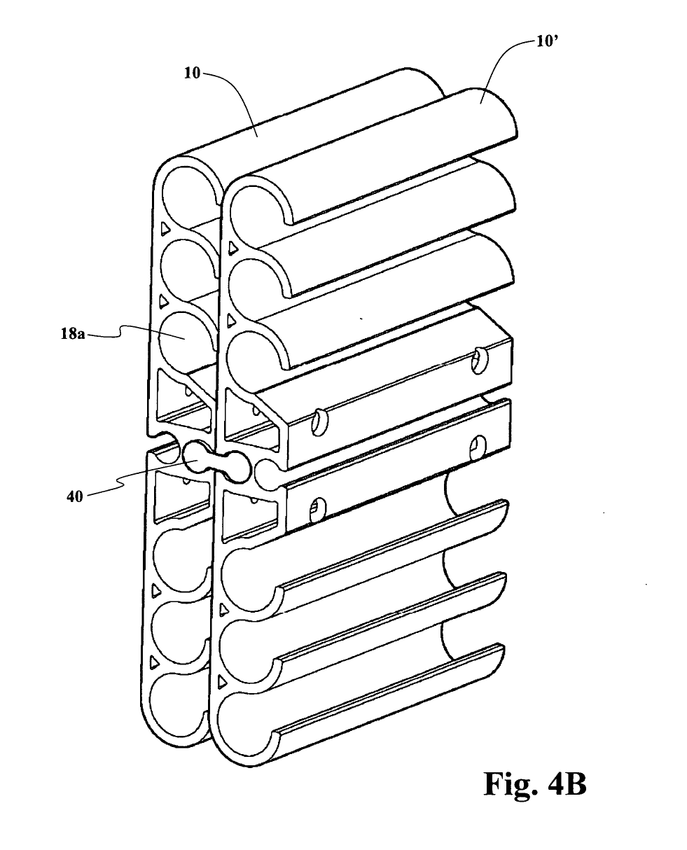

The present invention may be practiced in various embodiments. Three of those embodiments are depicted in the accompanying drawings. Specifically, FIGS. 1, 2A, and 2B depict one embodiment; FIGS. 3A, 3B, 3C, and 3E depict another embodiment; and FIGS. 4A and 4B depict yet a third embodiment. However, those with skill in this technology will appreciate from this disclosure that additional embodiments and equivalents fall within the scope of the appended claims.

With reference to the embodiment depicted in FIGS. 1, 2A, and 2B, a cable slack storage rack 10 is provided. The cable slack storage rack 10 comprises a first cable zone 12 and a second cable zone 14. A medial portion 16 is disposed between the first cable zone 12 and the second cable zone 14. In the embodiment depicted, the first cable zone 12 has multiple cable keepers 18a, 18b, and 18c. Likewise, the second cable zone 14 has multiple cable keepers 19a, 19b, and 19c. Each of the cable keepers defines therein an opening for receiving cable—cable keeper 18a defines therein an opening 20a; cable keeper 18b defines therein an opening 20b; cable keeper 18c defines therein an opening 20c, and so forth. In a similar fashion, cable keepers 19a, 19b, and 19c have respective openings 21a, 21b, and 21c. Although depicted with a equal number of cable keepers in both the first and second cable zones an unequal number of cable keepers is possible for the first and second cable zones.

In the embodiment depicted in FIG. 1, the cable slack storage rack 10 further includes apertures 46a, 46b that may be used for mounting the cable slack storage rack 10 on-site at a termination location. For example, one or more suitable fasteners may be used for securing cable slack storage rack 10 to a network device, telephone pole, or the like.

The embodiment of the cable slack storage rack 10 depicted in FIG. 1 further includes a plurality of stacking ribs 42a, 42b, 43a, 43b. Further, the same embodiment includes a plurality of stacking cavities 44, 45. In certain embodiments, a stacking rib, such as the stacking rib 42a, may be fabricated with a dovetail cross-sectional configuration. Similarly, in such embodiments, a stacking cavity, such as the stacking cavity 44, may be configured with cross-sectional dimensions adapted for snap-fit receipt of and engagement with a mating stacking rib 42a of another cable slack storage rack, such that multiple cable slack storage racks 10 may be interconnected and stacked one upon another by interfitting the stacking rib 42a into the stacking cavity 44, to provide for orderly, space saving storage of cable slack.

As depicted in FIG. 1, the cable keepers 18a-c, 19a-c may be provided with any suitable polygonal cross-sectional configuration. For example, a generally hexagonal cross-sectional configuration is depicted for the cable keepers in FIGS. 1, 2A, and 2B. However, as will be further disclosed, other cross-sectional configurations for the cable keepers may be used in certain applications without departing from the scope of the invention herein.

The openings 20a-c, 21a-c defined within the cable keepers 18a-c, 19a-c, respectively, may be biased toward the medial portion 16 of the cable slack storage rack 10. An example of such bias is depicted in FIG. 1, wherein cable keeper 18a, for example, does not face perpendicularly outward from the second cable zone 14 but instead, by reason of the positioning of the opening 20a defined within cable keeper 18a, is oriented angularly toward the medial portion 16 for improving the retention of the cable. FIGS. 2A and 2B illustrate the operation of such bias, as will now be described.

FIG. 2A is an environmental perspective view of the cable slack storage rack 10 mounted to a network device 96. In FIG. 2A, separate cable bundles 91, 92, 93 have been depicted in simplified form. The cable bundles 91, 92, 93 have been arranged in loops and have been compressed with opposing forces B, C (such as by manual manipulation by a technician). The cable bundles 91, 92, and 93, by reason of the stiffness of the cabling therein, resist the opposing forces B, C with a springback force.

As depicted by FIG. 2A, a cable slack storage rack 10 has been mounted to network device 96 at medial portion 16. In FIG. 2A, the particular network device 96 is an aerial closure for a local convergence point in a fiber optic network, such as that disclosed in U.S. Pat. No. 6,766,094, but any suitable network device can carry cable slack storage racks of the present invention. In other applications, a cable slack storage rack may be integrally fabricated as an included portion of a network device (not shown). In other words, the cable slack storage rack may be molded as a portion of the network device. In FIG. 2A, the cable slack storage rack 10 has been attached to the back of the network device 96, providing ease of access to the cable bundles 91, 92, 93 and for space savings without interfering with the operation of the network device 96.

Turning now to FIG. 2B, the cable bundles 91, 92, and 93 have been neatly stored in an organized fashion within a cable slack storage rack 10. Specifically, the cable bundle 91 has been stored within the cable keepers 18a, 19a. The cable bundle 92 has been neatly stored within the cable keepers 18b, 19b. The cable bundle 93 has been neatly stored within the cable keepers 18c, 19c. By reason of the combination of the bias of the openings 20 toward the medial section 16 and the inherent stiffness/springback of the cabling within the cable bundles 91, 92, 93 which tends to resist the coiling impressed upon them by such bundling and the forces B and C (see FIG. 2A), the cable bundle 91, for example, may be retained within the cable slack storage rack 10 by pressing against the interiors of the cable keepers 18a, 19a respectively. It will be appreciated that the size of the loops in which the cable bundles 91, 92, 93 have been formed can be manipulated in particular applications so as to avoid surpassing minimum bend radius specifications applicable to the particular cabling within the cable bundles 91, 92, 93, in that larger loops may be formed for cabling having greater minimum bend radius specifications, and smaller loops may be formed for cabling having smaller minimum bend radius specifications. For example, in one application involving fiber optic cables, bundles with a diameter of approximately thirty-two inches have been found to be preferable.

FIG. 2B further illustrates another aspect of the present invention. As depicted therein, a second cable slack storage rack 10′ may be moved in the direction D for installation upon the cable slack storage rack 10. So installed, the cable slack storage rack 10′ may provide the capability of stacking additional cable slack bundles upon those already neatly organized upon the cable slack storage rack 10, thereby providing stackability of multiple cable slack storage racks 10, 10′. Thus, the present invention allows for multiple cable storage racks on a single network device while still maintaining organization, minimum bend radii, etc.

FIGS. 3A, 3B, 3C, and 3E depict another embodiment of a cable slack storage rack 10. In the embodiment depicted in FIG. 3A, the cable slack storage rack 10 is depicted with a forward hinge barrels 25, 26. As depicted in FIG. 3B, a cable slack storage rack 10′ has been configured with rearward hinge barrels 27, 28. The hinge barrels 27, 28 may be configured and spaced such that, when the cable slack storage rack 10′ is positioned proximate to the cable slack storage 10, the hinge barrels 27, 28 align on either side, co-axially, with the hinge barrels 25, 26. The hinge barrels 25, 26 may include a first bore 60. Similarly, the hinge barrels 27, 28 may include co-axial bores 61, 62. The hinge barrels 25, 26, 27, 28 may thereby be adapted to receive within such bores 60, 61, 62 a hinge pin 24 for connecting racks into a cable slack storage system.

Note that the cable slack storage rack 10 may include hinge pin tabs 50, 51 for assembly. Similarly, as depicted in FIG. 3D, the hinge pin 24 may include indexing notches 30, 31, 32, 33, and a hinge pin handle 29. With reference to FIGS. 3C and 3E, a cable slack storage rack 10′ may be configured for stacking against a cable slack storage rack 10, thereby creating a modular cable slack storage system. The hinge barrels 27, 28 of cable slack storage rack 10′ may be disposed co-axially with the hinge barrels 25, 26 of the cable slack storage rack 10. A hinge pin 24 is then inserted in the direction F (FIG. 3C) through the bores 60, 61, 62 of the hinge barrels 25, 26, 27, 28. By manipulation of the hinge pin handle 29, the hinge pin 24 may be rotated such that the hinge pin tab 50 indexes within either indexing notch 32 or 33 and the hinge pin tab 51 indexes within either indexing notch 30 or 31, thereby securing the hinge pin 24 within the connected cable slack storage racks 10, 10′ together as is depicted in FIG. 3E.

With further reference to FIG. 3E, the cable slack storage rack 10′ may be rotated along the arc G such that a retention tab 34′ carried by the cable slack storage rack 10′ passes through and snap-fits within a shackle 35 carried by the cable slack storage rack 10. So connected, the cable slack storage racks 10, 10′ may provide an organized, stacked method of storing cable slack bundles. Should future access to any particular bundle stored within the cable slack storage rack 10 be required, such access may be achieved by depressing the retention tab 34′ and thereby releasing it from the shackle 35, allowing the cable slack storage rack 10′ to be rotated away from the cable slack storage rack 10, providing such access. As shown, cable slack storage rack 10′ also includes stand-offs (not numbered) in the medial portion for providing proper spacing between racks.

Returning to reference FIG. 3C, it will be appreciated that, by reason of provision of the hinge barrels 25′, 26′ carried by the cable slack storage rack 10′, another such cable slack storage rack (not shown) may be stacked upon, and mounted to, the cable slack storage rack 10′. As particular applications may require, multiple additional cable slack storage racks (not shown) may further be stacked upon such an assembly. Simply stated, the cable slack storage racks are modular for allowing the craft additional cable storage as necessary.

With further reference to FIG. 3A, it will be observed that, by use of the tabs 56, 57 projected toward the medial portion 16, the opening 20a is biased toward the medial portion 16. It will be further observed in FIGS. 3A, 3B, 3C, and 3E that the cable keepers 18a-c, 19a-c have a cross-section different than those depicted in FIGS. 1, 2A, and 2B, yet still falling within the scope of the present invention.

Still other embodiments of the concepts of the present invention are possible. By way of example, FIG. 4A depicts another cable slack storage rack 10. As shown, the medial portion 16 is configured to define coupling slots 36, 37, thereby providing this cable slack storage rack with a modular feature. Similarly, the cable slack storage rack 10′ may be configured to define therein a coupling slot 38. By moving the cable slack storage rack 10′ in the direction H to dispose the cable slack storage rack 10′ against the cable slack storage rack 10, a coupler 40 thereafter may be inserted into the coupling slots 37, 36′, thereby joining and stacking the cable slack storage rack 10′ with the cable slack storage rack 10. The coupler 40 depicted in FIGS. 4A, 4B is a dogbone coupler, but other configurations may likewise by employed with shapes complimentary to the configuration of coupling slots 37, 36′. By provision of the coupling slot 37′ in the cable slack storage rack 10′, an additional such cable slack storage rack (not shown) may be stacked upon and connected to the cable slack storage rack 10′ with a similar connection. FIG. 4B depicts the cable slack storage rack 10′ stacked upon the cable slack storage rack 10 by use of the coupler 40. It will still further be observed that the cable slack storage racks 10, 10′ depicted in FIGS. 4A, 4B illustrate a still further cross-sectional configuration of the cable keepers 18a-c, 19a-c, yet still falling within the scope of the present invention.

Cable slack may be quickly and easily stored in the cable slack storage racks depicted in the embodiments of FIGS. 3A, 3B, 3C, 3E or FIGS. 4A, 4B, in a similar manner to that depicted in FIGS. 2A, 2B. As such, the present invention provides for the orderly arrangement of multiple cable slack bundles at a single location, for the stacking of separate bundles, and for the avoidance of surpassing minimum bend radius specifications.

The foregoing is a description of various embodiments of the disclosure that are provided here by way of example only. Although the cable slack storage rack has been described with reference to the presently preferred embodiments and examples thereof, other embodiments and examples may perform similar functions and/or achieve similar results in the field. All such equivalent embodiments and examples are within the spirit and scope of the present disclosure and are intended to be covered by the appended claims and their equivalents. Moreover, although specific terms are employed herein, they are used in a generic and descriptive sense only and are not for purposes of limitation.

1. A cable slack storage rack, comprising:
a first cable zone and a second cable zone;
a medial portion disposed between said first cable zone and said second cable zone;
said first cable zone having at least one first cable keeper, said at least one first cable keeper is provided with a first cross-sectional configuration and defining an opening therein for receiving cable; and
said second cable zone having at least one second cable keeper, said at least one second cable keeper is provided with a second cross-sectional configuration and defining an opening therein for receiving cable.

2. The cable slack storage rack of claim 1, wherein said first cable zone has a plurality of cable keepers and said second cable zone has a plurality of cable keepers.

3. The cable slack storage rack of claim 2, wherein said first and second cable zone have an equal number of said cable keepers.

4. The cable slack storage rack of claim 1, wherein each said opening is biased toward said medial portion.

5. The cable slack storage rack of claim 1, wherein said first cable zone carries a pivot profile adapted to receive a hinge pin.

6. The cable slack storage rack of claim 5, wherein said second cable zone carries a retention tab.

7. The cable slack storage rack of claim 1, wherein the medial portion defines therein a coupling slot, said coupling slot being adapted to receive therein a coupler.

8. The cable slack storage rack of claim 1, wherein said cable slack storage rack defines a first side and an opposite second side, said first side carrying at least one stacking rib, said second side defining therein at least one stacking cavity.

9. The cable slack storage rack of claim 1, further including one or more stacking features for stackably connecting with a second cable slack storage rack.

10. The cable slack storage rack of claim 1, wherein said cable slack storage rack is carried by a network device.

11. A cable slack storage rack, comprising:
a first cable zone and a second cable zone;
a medial portion disposed between said first cable zone and said second cable zone;
said first cable zone carrying a plurality of cable keepers, each said cable keeper is provided with a first cross-sectional configuration and defining an opening therein for receiving cable; and
said second cable zone carrying a plurality of cable keepers, each said cable keeper is provided with a second cross-sectional configuration and defining an opening therein for receiving cable.

12. The cable slack storage rack of claim 11, wherein each said opening is biased toward said medial portion.

13. The cable slack storage rack of claim 11, wherein said first cable zone carries a pivot profile adapted to receive a hinge pin and said second cable zone carries a retention tab.

14. The cable slack storage rack of claim 11, wherein the medial portion defines therein a coupling slot, said coupling slot being adapted to receive therein a coupler.

15. The cable slack storage rack of claim 11, wherein said cable slack storage rack defines a first side and an opposite second side, said first side carrying at least one stacking rib, said second side defining therein at least one stacking cavity.

16. The cable slack storage rack of claim 11, further including one or more stacking features for stackably connecting with a second cable slack storage rack.

17. The cable slack storage rack of claim 11, wherein said cable slack storage rack is carried by a network device.

18. A cable slack storage rack, comprising:
a first cable zone and a second cable zone;
a medial portion disposed between said first cable zone and said second cable zone;
said first cable zone carrying a plurality of cable keepers, each said cable keeper is provided with a first cross-sectional configuration and defining an opening therein for receiving cable, each said opening being biased toward said medial portion;
said second cable zone carrying a plurality of cable keepers, each said cable keeper is provided with a second cross-sectional configuration and defining an opening therein for receiving cable, each said opening being biased toward said medial portion, wherein the cable slack storage rack includes one or more stacking features for stackably connecting with a second cable slack storage rack.

19. The cable slack storage rack of claim 18, wherein said first cable zone carries a pivot profile adapted to receive a hinge pin and said second cable zone carries a retention tab.

20. The cable slack storage rack of claim 18, wherein the medial portion defines therein a coupling slot, said coupling slot being adapted to receive therein a coupler.

21. The cable slack storage rack of claim 18, wherein said cable slack storage rack defines a first side and an opposite second side, said first side carrying at least one stacking rib, said second side defining therein at least one stacking cavity, said at least one stacking rib and said at least one stacking cavity adapted for mounting said cable slack storage rack.

22. The cable slack storage rack of claim 18, wherein said cable slack storage rack is carried by a network device.

23. The cable slack storage rack of claim 18, wherein said first and second cable zone have an equal number of said cable keepers.

24. The cable slack storage rack of claim 1, wherein the cross-sectional configuration is polygonal.

25. The cable slack storage rack of claim 24, wherein the cross-sectional configuration is hexagonal.

26. The cable slack storage rack of claim 11, wherein the cross-sectional configuration is polygonal.

27. The cable slack storage rack of claim 26, wherein the cross-sectional configuration is hexagonal.

28. The cable slack storage rack of claim 18, wherein the cross-sectional configuration is polygonal.

29. The cable slack storage rack of claim 28, wherein the cross-sectional configuration is hexagonal.
